(19) United States
(12) Patent Application Publication
(10) Pub. No.: US 2009/0109305 A1
(43) Pub. Date: Apr. 30, 2009

(54) One-step black level calibration for image sensors

(76) Inventors: Tiejun Dai, Sunnyvale, CA (US); Xiaodong Luo, San Jose, CA (US); Xiangchen Xu, Milpitas, CA (US)

Correspondence Address: BLAKELY SOKOLOFF TAYLOR & ZAFMAN LLP, 1279 Oakmead Parkway, Sunnyvale, CA, 94085-4040, US

(21) Appl. No.: 11/981,005

(22) Filed: Oct. 31, 2007

(51) Int. Cl. H04N 9/64; H04N 9/04; G03F 3/08; H04N 5/00; H04N 5/335; H04N 3/14; H04N 9/083; H04N 5/16

(52) U.S. Cl. 348/245; 348/257; 348/615; 358/529

(57) ABSTRACT

Embodiments of a process comprising receiving a plurality of offset analog signals, each corresponding to one of a plurality of black pixels in a pixel array; obtaining a corresponding digital value for each offset analog signal; computing an average of the digital values; and computing a black-level offset that, if applied to the digital values, would make the average of the digital values equal to a target value. Also disclosed are embodiments of an apparatus comprising an analog-to-digital converter coupled to an analog channel to receive offset analog black pixel signals from the analog channel and to obtain a corresponding digital value for each offset analog signal; circuitry and logic coupled to the analog-to-digital converter to average the digital values corresponding to the black pixels and compute a black-level offset that, if applied to the digital values of the black pixels, would make the average of the digital values of the black pixels equal to a target value.

### TECHNICAL FIELD

The present invention relates generally to image sensor calibration and in particular, but not exclusively, to single-step black level calibration of an image sensor.

### BACKGROUND

Image sensors such as CMOS or CCD sensors are made up of an array of individual pixels, each of which collects photons incident on the image sensor. The number of photons collected in each pixel is converted into an electrical charge by a photodiode and this charge is then converted into an analog voltage, amplified, and converted to a digital value by an analog-to-digital converter, so that the information obtained from the individual pixels can be processed, usually by a digital signal processor, into a final digital image.

Most image sensors require some form of calibration before use so that the data obtained from the image sensor can be used to produce digital images that faithfully reproduce the optical characteristics (intensity, color, etc) of the scene or object whose image was captured. Some calibrations can be carried out once and remain valid for every subsequent use of the image sensor, but other calibrations must be carried out for every single use of the image sensor. Black level calibration is one of the calibrations usually performed for every single use of an image sensor. As its name implies, the purpose of a black level calibration is to determine the black level of the image sensor; the black level calibration effectively sets a threshold below which digital data values obtained from the image sensor will be considered to represent a black level—or, in other words, to represent the absence or substantial absence of light. The threshold value is then used to adjust the values obtained from other pixels in the array. Accurate black-level calibration helps to achieve a digital picture with full contrast and subtle details in dark shadow regions. If the black level is too low, information in dark areas may be lost; if the black level is too high, signal range may be sacrificed.

Currently black level calibration of image sensors is carried out iteratively based on an average of black pixels. To perform the calibration, data is read from black pixels on the image sensor, averaged, and an analog adjustment is computed that will drive the average toward the desired value. Using the computed analog adjustment, a new adjusted image is then captured, averaged, and another adjustment is computed that again drives the black average toward the desired value. This iterative process continues until the black average reaches the desired value.

As currently done, black level calibration has several disadvantages, most notable of which is the iterative nature of the process. Since a black level calibration must be performed every time the image sensor is used to capture an image, the iterative calibration significantly slows down the ability of the image sensor to capture images. Other problems exist as well, for example the inherent inaccuracy of making analog adjustments.

### SUMMARY OF THE INVENTION

Disclosed are embodiments of a process comprising receiving a plurality of offset analog signals, each corresponding to one of a plurality of black pixels in a pixel array; obtaining a corresponding digital value for each offset analog signal; computing an average of the digital values; and computing a black-level offset that, if applied to the digital values, would make the average of the digital values equal to a target value. Also disclosed are embodiments of an apparatus comprising an analog-to-digital converter coupled to an analog channel to receive offset analog black pixel signals from the analog channel and to obtain a corresponding digital value for each offset analog signal; circuitry and logic coupled to the analog-to-digital converter to average the digital values corresponding to the black pixels and compute a black-level offset that, if applied to the digital values of the black pixels, would make the average of the digital values of the black pixels equal to a target value.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1A is a schematic plan view of an embodiment of a two-dimensional image sensor.

FIG. 1B is a graph illustrating an embodiment of output from an image sensor such as the one shown in FIG. 1A.

FIG. 2 is a schematic block diagram illustrating an embodiment of an apparatus for performing a black-level calibration.

FIGS. 3A-3C are graphs illustrating an embodiment of a single-step black-level calibration of an image sensor such as the one shown in FIG. 1.

FIG. 4 is a schematic block diagram of an embodiment of a system including an embodiment of an apparatus for black-level calibration of an image sensor.

### DETAILED DESCRIPTION OF THE ILLUSTRATED EMBODIMENTS

Embodiments of an apparatus, system and method for black level calibration of an image sensor are described herein. In the following description, numerous specific details are described to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail but are nonetheless encompassed within the scope of the invention.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in this specification do not necessarily all refer to the same embodiment. Furthermore, the particular features, structures, or characteristics may be combined in any suitable manner in one or more embodiments.

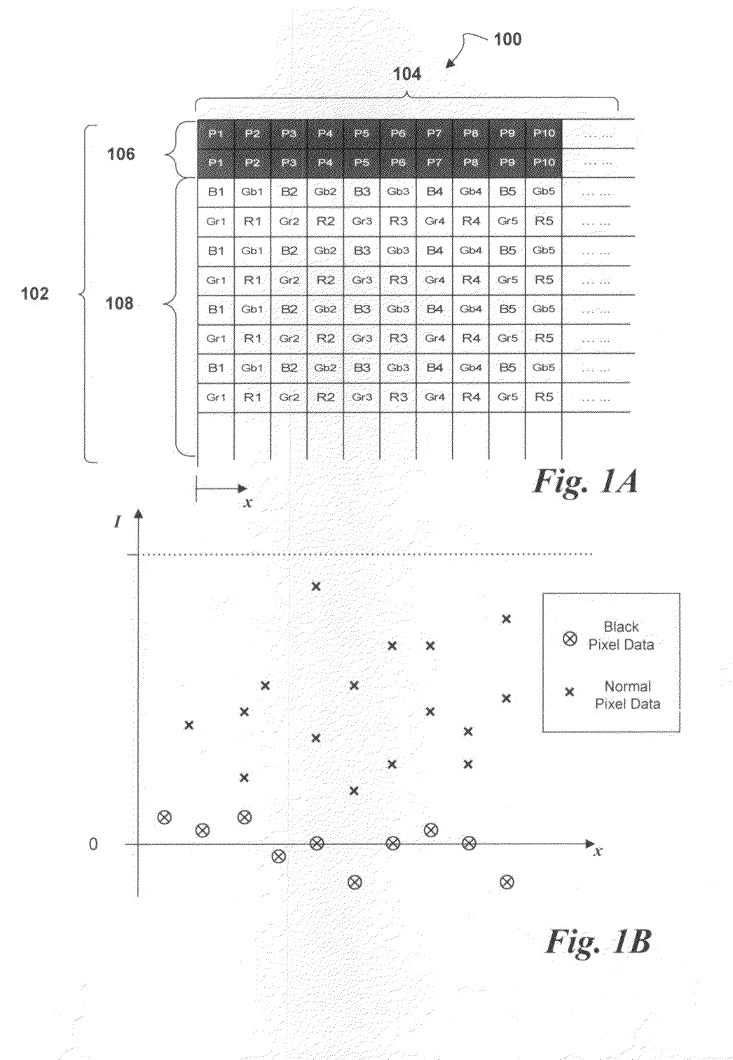

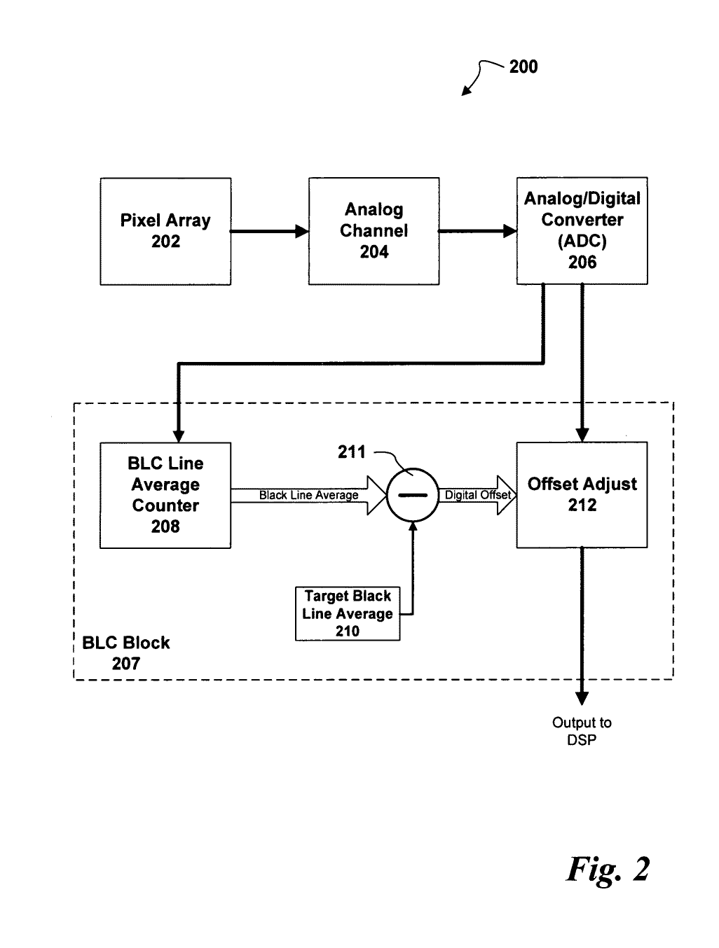

FIG. 1A schematically illustrates an embodiment of an image sensor 100. Image sensor 100 includes a two-dimensional pixel array having a plurality of pixels arranged in rows 102 and columns 104. Image sensor 100 includes rows of black pixels 106 that are used for calibration. Black pixels 106 are designed to prevent light from reaching the light detection portion of the pixel. In one embodiment black pixels 106 can be covered with an opaque material such as a metal, so that no light can reach the light detector portion of the pixel. In other embodiments, other methods can be used for preventing light from reaching the light detector portions of the pixels; for example, a shutter could be used to block one or more rows or columns of pixels so that they receive no light. The illustrated pixels array is regularly shaped, but in other embodiments the array can have an arrangement different than shown and can include more or less pixels, rows and columns than shown. Moreover, although the illustrated embodiment is a color image sensor including red (R), green (Gr) and blue (B) pixels designed to capture images in the visible portion of the spectrum, in other embodiments the image sensor can be a CMY sensor or a black-and-white image sensor and/or can be an image sensor designed to capture images in the invisible portion of the spectrum, such as infra-red or ultraviolet.

FIG. 1B illustrates an embodiment of the output from an image sensor such as image sensor 100. In the graph, the horizontal axis represents the x position of each pixel, while the vertical axis represents the intensity I of the analog output from each pixel, which can be characterized and measured using various physical quantities such as current, voltage or charge. The output from normal pixels (i.e., non-black pixels) 108 is plotted on the graph with open symbols (x), while the output from the black pixels 106 is plotted with closed symbols ( [symbol] ). Since black pixels 106 receive no light, they should theoretically have no output; in other words, each output from a black pixel (known as the “black level” of image sensor 100) should be zero on the intensity scale. But several factors, including, for example, manufacturing defects and/or current leakage between transistors and other elements within each pixel, cause black pixels 106 to have a non-zero output, which then creates a need for a black-level calibration of image sensor 100.

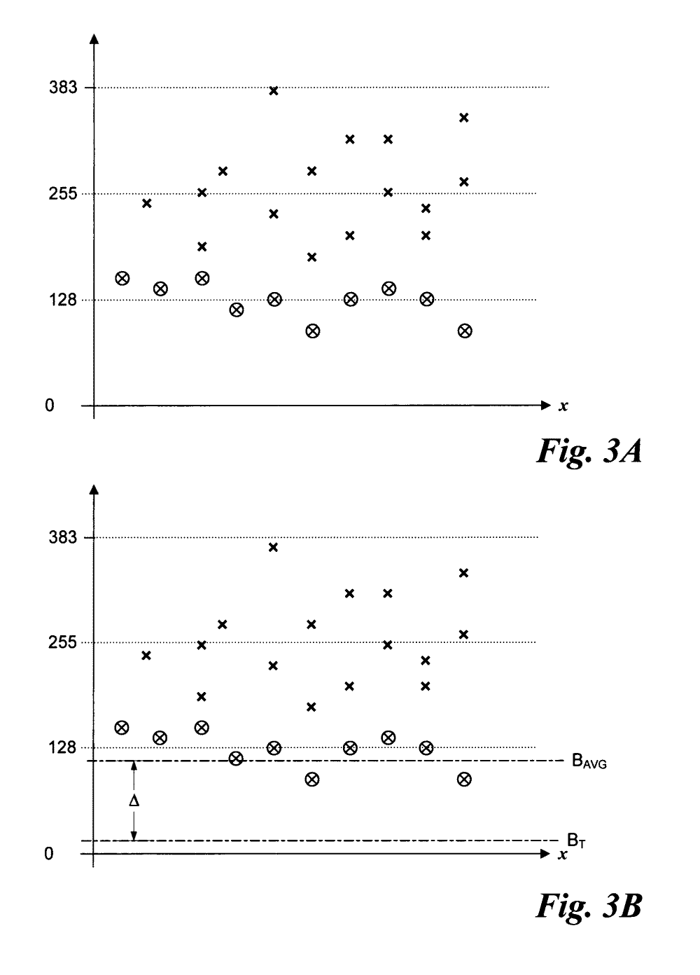

FIG. 2 illustrates an embodiment of an apparatus 200 for performing a fast, single-step black-level calibration for an image sensor such as image sensor 100. Apparatus 200 includes an image sensor comprising a pixel array 202 coupled to an analog channel 204. Analog channel 204 is also coupled to analog-to-digital converter (ADC) 206, which is then coupled to components within a black-level calibration (BLC) block 207. Black-level calibration block 207 includes two main components to which analog-to-digital converter 206 is coupled: BLC line average counter 208 and offset adjust 212. Also coupled to both BLC line average counter 208 and offset adjust 212 is a component 211 that can perform mathematical operations on data output by the BLC line average counter.

Pixel array 202 can be any kind of pixel array that includes black pixels; in one embodiment, pixel array 202 can be the same as, or similar to, the pixel array described above in connection with image sensor 100 (see FIG. 1A). As with image sensor 100, in different embodiments pixel array 202 can include one or more of the variations discussed above for image sensor 100.

Analog channel 204 is coupled to pixel array 202 to receive and condition analog signals from each pixel within pixel array 202. In different embodiments, analog channel 204 can include various components to condition an analog signal such as filters, amplifiers, offset circuits, automatic gain control, etc. Among other signal conditioning functions, analog channel 204 can be used to add an offset to the analog signal received from each pixel in pixel array 202. In one embodiment, analog channel 204 can offset the analog signals received from pixel array 202, so that after it is digitized in ADC 206 the digital data will occupy a new data range that is expanded by a specified fraction (between 0 and ±1) of the normal data range. For example, in an embodiment where ADC 206 would digitize an analog signal with no offset such that the data values would range from 0 to about 255 (or 0 to about FF in hexadecimal notation), analog channel 204 can be set to offset the analog signals so that the digital data range increases by half and now occupies a range between 0 and about 383.

Analog-to-digital converter (ADC) 206 is coupled to analog channel 204 to receive conditioned analog signals corresponding to each pixel in pixel array 202 from analog channel 204 and convert them into digital values. The range of digital values that can be represented by ADC 206 depends in part on the bit length it uses for the data, although for a given bit length changes in the programming of ADC 206 can allow it to emulate longer bit lengths. In an embodiment where, for example, ADC 206 represents the data with 8-bit numbers, the data can take on 2⁸ (i.e., 256) different values, for example between 0 and about 255 (or 0 to FF in hexadecimal notation). In another embodiment, the data range of ADC 206 can be extended simply by extending the bit length of the data; for each 1-bit increase in the bit length, the data range that can be represented doubles. Thus, by using 9-bit data ADC 206 can have 2⁹ different values, giving it a data range, for example, between 0 and 511 (or 0 to 3FF in hexadecimal notation). In still other embodiments of ADC 206 the data bit length can be greater than 9 bits, for example 11 bits, or can use different bit lengths for different data, for example 11-bit data for black pixels and 8-bit data for non-black pixels.

BLC block 207 uses the digital black pixel data received from ADC 206 to compute the black level calibration and apply it to the non-black digital pixel data. Within BLC block 207, BLC line average counter 208 receives the digital black pixel data from ADC 206, computes the average of the digital values of the black pixels, and outputs this black-line average value to element 211. Element 211 receives the black line average from BLC line average counter 208 and also receives a value for the target black line average. Based on these two values, element 211 computes a digital offset that, if applied to the digital black pixel values, would make the black line average substantially equal to the target black line average. In various embodiments, the target black-line average can be set to any desired value. In one embodiment, for example, the target black line average can be set substantially equal to zero; setting the target black line average at zero allows use of the maximum dynamic range of the image sensor.

After element 211 computes the digital offset, the value of the digital offset is transmitted to offset adjust block 212. Offset adjust block 212 is coupled to ADC 206 and receives the digital data corresponding to the non-black pixels from the ADC. Offset adjust block 212 then applies the digital offset from element 211 to each digital value corresponding to a non-black pixel and outputs the digitally offset non-black pixel data to other components such as a digital signal processor (DSP) for further processing. The non-black pixel data, like the black pixel data, was originally offset by a certain amount in analog channel 204, meaning that when originally digitized the non-black pixels occupied an expanded data range. By applying the digital offset from element 211 to the digital values corresponding to non-black pixels, the digital values of the non-black pixels are brought back within the original data range.

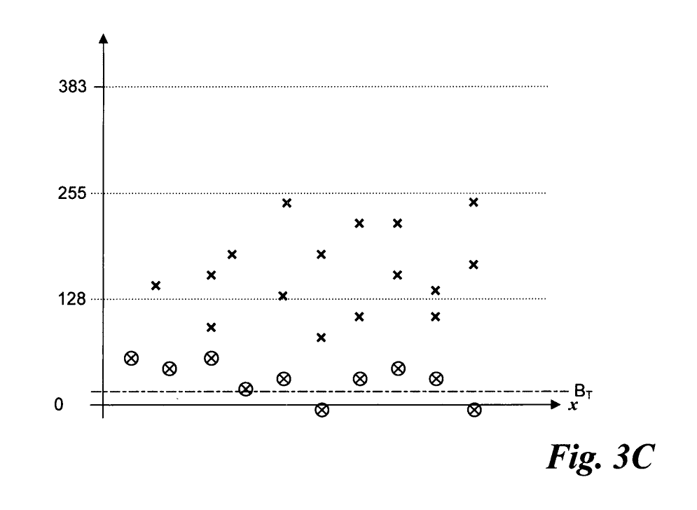

FIGS. 3A-3C graphically illustrate an embodiment of a single-step black level calibration carried out by apparatus 200. As in FIG. 1B, in each of FIGS. 3A-3C the horizontal axis represents the x position of the pixels, while the vertical axis represents the output from each pixel. The output from normal pixels (i.e., non-black pixels) is plotted on each graph with open symbols (x), while the output from the black pixels is plotted with closed symbols ( [symbol] ). FIG. 3A illustrates the data from the pixels after initial digitizing of the offset analog signal received at ADC 206 from analog channel 204. Because of the analog offset applied to the signal in analog channel 204, the data from all pixels—black and non-black alike—has been shifted upward. In the illustrated embodiment, the pixel data would typically be represented with 8-bit numbers, and thus have a data range between 0 and 255. The analog offset applied in analog channel 204 results in an upward shift in the corresponding digital data approximately equal to half the 8-bit data range, such that the digital data fall in the range about from 0 to 383. To accommodate this expanded data range, the digital data obtained from the offset analog data must be represented by numbers having 9 or more bits, or some provision must be made in the programming of DSP 206 that will allow the DSP to emulate more than 8 bits to accommodate the expanded data range.

FIG. 3B illustrates an embodiment of the computation of the digital offset that will be used to effect the black-level calibration. First, the average B_{AVG} of the black-pixel data is computed by BLC line average counter 208. Once B_{AVG} is computed, the target black-level average B_{T} is established. In the embodiment shown, B_{T} is a non-zero number, but as discussed above in other embodiments, the target black-level average can be set to any number, including zero. Knowing the existing black-level average B_{AVG} and the target black-level average B_{T}, the offset Δ required to make the black-level average zero is the difference between the existing value and the target value:

Δ=B_{T}—B_{AVG}

Thus, if all the black-pixel data were shifted downward by an amount Δ, the black average value would become the same as the target black average.

FIG. 3C illustrates an embodiment of the application of the digital offset to the non-black pixel data from image sensor/pixel array 202. In the apparatus embodiment shown in FIG. 2, this function can be performed by offset adjust 212 before sending the data to a digital signal processor or other component. After the digital offset is computed as shown in FIG. 3B, the non-black pixel data that was held in ADC 206 while the digital offset is computed is sent from ADC 206 to offset adjust 212, where the value of the digital offset is then applied to the non-black pixel data. In the illustrated embodiment, the formulation of the digital offset is such that applying it to the non-black pixel data means that that the digital offset is added to the non-black pixel data; where the digital offset is a negative value, subtraction is the net result of adding the digital offset to the non-black pixel data. In other embodiments, however, the digital offset could be formulated so that it is applied to the digital offset by multiplication, division, or some other mathematical operation.

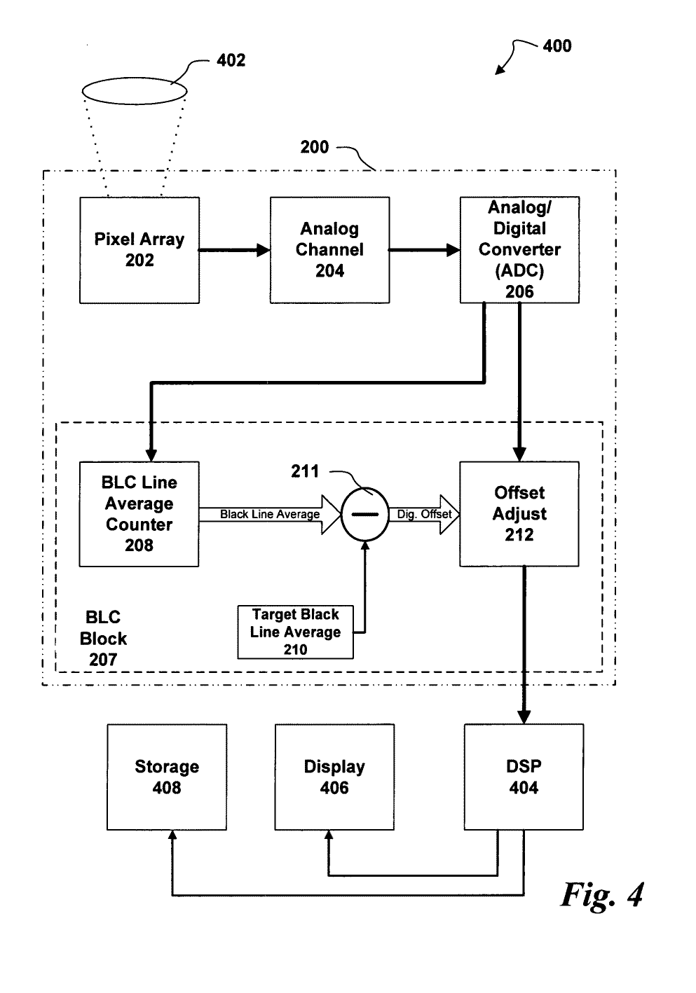

FIG. 4 illustrates an embodiment of an imaging system 400 employing a black-level calibration apparatus such as the black-level calibration apparatus 200 described in FIG. 2. Optics 402 are coupled to pixel array 202 to focus an image onto the pixels in pixel array 202. Pixel array 202 captures the image and the remainder of apparatus 200 processes the black and non-black pixel data from the image as described above in connection with FIGS. 2 and 3A-3C. Once the black-level calibration has been applied to the image, the image is output from offset adjust 212 to a digital signal processor (DSP) 404, where it can be further processed to create the final image data. DSP 404 can then output the final image data to one or both of a display unit 406 and a storage unit 408.

The above description of illustrated embodiments of the invention, including what is described in the abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description.

The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A process comprising:
receiving a plurality of offset analog signals, each corresponding to one of a plurality of black pixels in a pixel array;
obtaining a corresponding digital value for each offset analog signal;
computing an average of the digital values; and
computing a black-level offset that, if applied to the digital values, would make the average of the digital values equal to a target value.

2. The process of claim 1 wherein the target value is equal to or greater than zero.

3. The process of claim 1, further comprising:
receiving a plurality of offset analog signals, each corresponding to one of a plurality of non-black pixels in the pixel array;
obtaining a corresponding digital value for each offset analog signal from a non-black pixel; and
applying the black-level offset to digital values corresponding to the non-black pixels.

4. The process of claim 3 wherein applying the black-level offset to the digital values corresponding to non-black pixels comprises adding the black-level offset to the digital value corresponding to each non-black pixel.

5. An apparatus comprising:
an analog-to-digital converter coupled to an analog channel to receive offset analog black pixel signals from the analog channel and to obtain a corresponding digital value for each offset analog signal;
circuitry and logic coupled to the analog-to-digital converter to:
average the digital values corresponding to the black pixels, and
compute a black-level offset that, if applied to the digital values of the black pixels, would make the average of the digital values of the black pixels equal to a target value.

6. The apparatus of claim 5 wherein the target value is equal to or greater than zero.

7. The apparatus of claim 5 wherein the analog-to-digital converter further receives offset analog non-black pixel values and the circuitry and logic further apply the black-level offset to digital values corresponding to the non-black pixels.

8. A system comprising:
a pixel array including a plurality of black pixels and a plurality of non-black pixels;
an analog channel coupled to the pixel array, wherein the analog channel applies an analog offset to signals obtained from the plurality of black pixels and the plurality of non-black pixels;
an analog-to-digital converter coupled to the analog channel to obtain corresponding digital values for each offset analog signal received from the analog channel;
circuitry and logic coupled to the analog-to-digital converter to:
average the digital values of the black pixels, and
compute a black-level offset that will make the average of the digital values of the black pixels equal to a target value.

9. The system of claim 8, further comprising optics coupled to the pixel array.

10. The system of claim 8, further comprising an offset adjust to apply the black-level offset to data corresponding to non-black pixels.

11. The system of claim 8, further comprising a digital signal processor coupled to the offset adjust.

12. The system of claim 11, further comprising at least one of a display and a storage unit coupled to the digital signal processor.
